(19) United States
(12) Patent Application Publication
(10) Pub. No.: US 2004/0062546 A1
(43) Pub. Date: Apr. 1, 2004

(54) Washing method and apparatus

(75) Inventors: Gareth B. Evans, Hertfordshire (GB); Peter Hewitson, Middlesex (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/649,501

(22) Filed: Aug. 26, 2003

(30) Foreign Application Priority Data
Aug. 31, 2002 (GB) 0220263.8

(51) Int. Cl. G03D 3/00

(52) U.S. Cl. 396/564

(57) ABSTRACT

A method of washing contaminants from a coated surface of a material transports the material up an inclined substantially planar surface and introduces wash solution at the upper part of the planar surface. The planar surface incorporates substantially non smooth resistance means which provides a resistance to downward flow of the wash solution and has a capacity for holding wash solution which is in excess of that of a substantially smooth surface.

### CROSS REFERENCE TO RELATED APPLICATIONS

This is a U.S. original patent application which claims priority on Great Britain patent application No. 0220263/8 filed Aug. 31, 2002.

### FIELD OF THE INVENTION

This invention relates to the washing of sheets of material which contain substances requiring washing for their removal. The invention relates in particular to the washing or stabilisation stage of the photographic processing of colour film and paper. The invention will be described with reference to a system for washing photographic paper.

### BACKGROUND OF THE INVENTION

There is a need in the photographic industry to remove substances from processed material to ensure image stability. In deep-tank replenished processing systems material passes from one tank to the next. For example, with respect to processing of colour paper, the material passes through a first tank for development, a second tank for bleach/fix and then into a series of wash or stabiliser tanks. The wash tanks are usually inter-connected so that clean washing solution is added to the last of the tank series and the over-flow from the last tank is transferred to the previous tank and so on. In this way the flow of solution is in a direction which is counter to the direction of transport of the paper. This so-called counter-current flow technique enables efficient washing since when the material has the highest content of substances to be removed, the wash solution also has the highest concentration of removed substances and clean solution is only used in the last step when the processed material contains little removable contaminants.

The table below is derived from a mathematical model which predicts the fraction of contaminants remaining in colour paper after a four-tank counter-current wash stage in which 194 ml/m² of solution is added to the last tank. High agitation is assumed which allows equilibrium between substances in the solution and processed material to be rapidly established.

| Counter-Current | Multiple Wash | |
|---|---|---|
| Number of tanks | 4 | 4 |
| Fraction of material left | 0.00067 | 0.00062 |
| Total Volume (ml per m²) | 194 | 776 |
| Total time @ 22.5 sec per tank | 90 | 90 |

The technique of counter-current washing is widely if not universally adopted with small, so-called Minilab or Microlab equipment and is often also used in large-scale wholesale equipment. More efficient washing can be achieved if more tanks are used in a counter-current series. However, the tanks are bulky and require pumps to provide adequate re-circulation and agitation. Each additional tank incurs additional cost and maintenance. Shorter washing times can be achieved if the time in each tank is reduced below that required for the material in the coating to be in equilibrium with the material in solution. This can be achieved without undue loss of washing efficiency. For example U.S. Pat. No. 6,106,169 describes a multi-tank unit in which all but the last tank is insufficiently long to provide an immersion time sufficient to reach equilibrium. This unit was found to produce good results with a seven tank configuration giving a total wash-stage time of 20 seconds using as little as 9 ml/m² of solution.

By reducing the tank volumes, shaping them appropriately and allowing the paper to be transported with the coated side against the curved surface of the interior of the tanks, the agitation/re-circulation pumps could be avoided. However this arrangement required the provision of seven tanks with six cross-over devices to pass the paper from one tank to the next. Such cross-over devices, usually a set of at least two rollers, are expensive and require cleaning and maintenance.

An alternative approach to using curved surfaces in the above multi-stage unit is to use substantially planar, inclined surfaces. The so-called “Inclined Ramp” washing system, see EP 908767, provided a single plane at a 45° angle, to guide the paper in an upward direction with the coated side of the paper against the plane surface. Cleaning/washing solution was added to the top of the inclined plane and ran under gravity under the paper. This surface was not smooth but was textured to provide some agitation. Theoretically this provides a very large number of tanks in a way which is analogous with the theoretical plates of a distillation column. Although each “tank” provides inefficient washing due to the short residence time, the opportunity for material exchange between the paper and increasingly clean water is continuously available. In practice, the efficiency of this device was not high. This was possibly due to the ability of the wash solution to find pathways under the paper surface which allowed rapid descent of a substantial part of the solution. Also in this type of arrangement, it is possible for the paper to drag water from the lower end of the ramp where the solution contains high concentrations of extracted substances to the upper parts, thus contaminating the relatively clean solution flowing down the surface.

The problem to be solved is to provide a washing system which is efficient in terms of solution usage and washing time and is mechanically simple and inexpensive. In particular it should provide at least as effective washing as a four tank system replenished at 194 ml/m² in 90 seconds or a seven-tank system replenished at 118 ml/m² in 30 seconds in a way which requires substantially fewer mechanical parts.

The invention seeks to overcome problems which occur with the previously disclosed inclined plane processor, namely the escape from the paper surface of wash solution before washing can be effected and the dragging of solution up the surface by the washed material.

### SUMMARY OF THE INVENTION

According to the present invention there is provided a method of washing substances from a coated surface of a material, the material being transported up at least one inclined substantially planar surface and wash solution being introduced at the upper part of the inclined planar surface between the surface and the material, the planar surface incorporating substantially non-smooth resistance means providing a resistance to downward flow of the wash solution and having a capacity to hold wash solution in excess of that of a substantially smooth surface.

The invention further provides an apparatus for washing substances from a coated surface of a material, the apparatus comprising at least one inclined substantially planar surface along which the material is passed, an inlet for the introduction of wash solution being provided at the upper part thereof, the planar surface incorporating substantially non smooth resistance means providing a resistance to downward flow of the wash solution and having a capacity to hold wash solution in excess of that of a substantially smooth surface.

Preferably the resistance means comprises a cover of a fibrous material.

The invention provides efficient and rapid washing. It further provides mechanical simplicity and low manufacturing costs relative to multi tank processing systems.

A further advantage of the invention is that the wash solution is not retained in tanks between periods of use but is readily removed. The low “holding” volume of the surface relative to a series of tanks allows the solution to be discarded without excessive generation of effluent volume. The short residence time of the solution in the processor means that growth of micro organisms leading to dirt and slime is inhibited.

### BRIEF DESCRIPTION OF THE DRAWINGS

The invention will now be described, by way of example, with reference to the accompanying drawings, in which:

FIG. 1 is a schematic view of an embodiment of the invention; and

FIG. 2 is a schematic view of one embodiment of a cover.

### DETAILED DESCRIPTION OF THE INVENTION

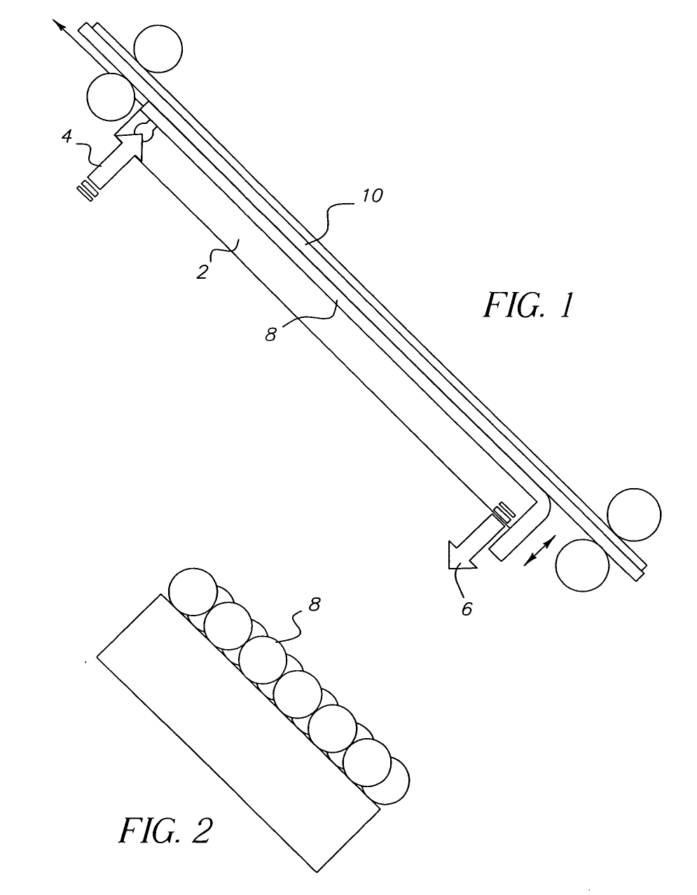

FIG. 1 is a schematic view of an embodiment of the invention.

Referring to FIG. 1 there is provided a substantially planar inclined surface 2. An inlet 4 for the introduction of fresh wash solution is located at the upper end of the inclined surface 2. An outlet 6 for the solution is located at the lower end of the surface 2. The surface 2 is either covered with a material, such as fabric or other material, or has a surface characteristic which provides resistance to flow and a capacity to hold solution. FIG. 1 illustrates the surface covered with a fabric. In the case of a fabric cover 8 the surface provides resistance to flow and a capacity to hold solution in the plane of the fabric by soaking up the wash solution within the fibres. This ensures that the solution flows down the plane within the bulk of the fabric cover and not over the surface of the plane in a gap between the plane and the material to be washed, 10, hereinafter referred to as paper, in a way which enables the wash solution to escape from the wash stage before carrying out its washing function. It is important therefore that the capacity of the fabric cover on the plane and the resistance to flow within the fabric cover are such as to enable the wash solution to flow within the bulk of the fabric cover at a flow rate which is consistent with the rate of transport of paper or other washed material and the required efficiency of washing. The fibres further provide agitation which encourages contaminants out of the paper and into the wash solution. The fibres further provide a means of preventing the contaminated solution being dragged up the inclined surface 2 by the paper.

Rollers or other transportation means, not shown, convey the paper to be washed up the inclined surface 2. The paper may be in sheet form or be a continuous web of coated material.

It is desirable in processing equipment which is used only intermittently for the capacity of the fabric cover to be low since the solution would normally drain out of the fabric after a batch of processed material has been washed. The discarded solution would then add to the total liquid effluent produced by the process. This is particularly important if single prints are infrequently processed. Low capacity of the fabric cover results, for a given rate of paper transport and rate of wash solution usage per unit area of paper, in faster flow in linear terms of solution flowing down the inclined surface. The viscosity of the solution combined with the resistance provided by the fabric cover are factors which determine the flow of solution. It is important that these factors are such as to allow flow within the fabric cover and that the flow capacity of the surface is not exceeded, a situation which would encourage separation of the fabric cover from the paper and the premature escape of solution.

In operation the paper 10 is transported up the inclined surface 2. The paper 10 is fed up the surface with the coated side thereof in contact with the cover 8. Wash solution is fed through the inlet 4 and flows downwards under gravity towards the outlet 6 under the paper 10. The surface 2 is not a truly smooth continuous surface. Due to the fabric cover 8 the time taken for the descent of the wash solution down the inclined plane is substantially longer than the time taken for the descent of the same solution down a smooth planar surface. The time taken for the wash solution to flow down a length of the inclined plane can lie between 0.1 and 30 times the time taken for the material to pass up over the same length. As the wash solution passes down the plane and through the fabric cover the contaminants leave the paper 10 and are transferred to the wash solution in the fabric cover 8. The contaminated wash solution passes out through the outlet 6 located at the lower part of the inclined surface. The paper 10 is removed at the upper end of the inclined surface 2 and guided to a drying stage (not shown).

It will be appreciated that a fabric cover is only one of the options which may be used to practice the invention. In this embodiment the fibres provide resistance to flow in the plane of the fabric, as stated above. The fabric is preferably a velvet or felt material. Velvet is the preferred option. These fabrics do not scratch the surface of the paper and provide good agitation. Other textured surfaces may be used. For example, a single layer of identically sized, close packed spheres could be used. These spheres could be made of plastics, glass or some other impermeable material.

The rate of descent of the wash solution is related to the rate of ascent of the paper 10. If the rate of descent is too slow the contamination of the wash solution in the upper parts of the plane will be excessive. This would leave too short an exposure of the paper to clean solution. If the rate of descent is too fast an excessive amount of solution will be used. The slope of the plane can be adjusted to provide adjustment of the rate of descent of the solution. The textured surface of the inclined plane can also inhibit the dragging of contaminated solution up the plane. The necessary contact time of the paper with the washing surface will depend on the rate at which contaminants diffuse from the paper. Some contaminants such as salts will diffuse quickly. Others may be associated with substances within the paper coating, such as gelatin or dispersed oily liquids, and will take longer to be extracted.

It is important that the wash solution flows in a way which is controlled by the nature of the surface 2 and does not, for example, flow over a surface relatively unaffected by the nature of the surface. Other ways other than those described above may be employed to reduce the flow rate of solution down the plane of the surface 2. For example, an impervious surface may be provided with grooves or channels. These grooves and channels provide a capacity for the surface 2 to hold solution and to control descent of the solution. The grooves and channels could be formed in wavy or zigzag lines.

Cross web uniformity of washing may be improved by providing, along the length of the surface, opportunities for the solution to flow readily in the direction perpendicular to the direction of paper transport. For example, a series of channels could be cut into the surface 2. These channels may be in the order of a few millimetres in width and a few centimetres apart. Alternatively a ribbed pattern, with the ribs running across the plane would perform the same function. It would also be possible to connect the channels so as to provide a sinuous path for the wash solution to follow. In this embodiment the channel would control the descent rate of the solution and the fabric cover's role would be to carry the solution to the paper surface and provide agitation.

Although the invention has been described with reference to paper it will be understood that the invention is equally applicable to film.

It is to be understood that various modifications and changes may be made without departing from the present invention, the present invention being defined by the following claims.

PARTS LIST

| | |
|---|---|
| 2 | inclined surface |
| 4 | inlet |
| 6 | outlet |
| 8 | cover |
| 10 | paper |

What is claimed is:

1. A method of washing substances from a coated surface of a material, the material being transported up at least one inclined substantially planar surface and wash solution being introduced at the upper part of the inclined planar surface between the surface and the material, the planar surface incorporating substantially non-smooth resistance means providing a resistance to downward flow of the wash solution and having a capacity to hold wash solution in excess of that of a substantially smooth surface.

2. A method as claimed in claim 1 wherein the resistance means is provided by a cover.

3. A method as claimed in claim 2 wherein the cover is of a fibrous material.

4. A method as claimed in claim 1 wherein the time taken for the wash solution to flow down a length of the inclined surface is between 0.1 and 30 times the time taken for the material to pass up over the same length.

5. A method as claimed in claim 1 wherein the material being washed is photographic material.

6. Apparatus for washing substances from a coated surface of a material, the apparatus comprising at least one inclined substantially planar surface along which the material is passed, an inlet for the introduction of wash solution being provided at the upper part thereof, the planar surface incorporating substantially non smooth resistance means providing a resistance to downward flow of the wash solution and having a capacity to hold wash solution in excess of that of a substantially smooth surface.

7. Apparatus as claimed in claim 6 wherein the resistance means comprises a fibrous material.

8. Apparatus as claimed in claim 6 wherein the resistance means comprises a velvet material.

9. Apparatus as claimed in claim 6 wherein the resistance means comprises a felt material.

10. Apparatus as claimed in claim 6 wherein the resistance means comprises a layer of closely packed spheres.

11. Apparatus as claimed in claim 6 wherein the resistance means is provided by a number of grooves in the planar surface.

12. Apparatus as claimed in claim 6 wherein the planar surface is further provided with a series of channels across the width thereof.

13. Apparatus as claimed in claim 6 wherein the planar surface is further provided with a series of ribs across the width thereof.
